(19) United States
(12) Patent Application Publication
(10) Pub. No.: US 2008/0295438 A1
(43) Pub. Date: Dec. 4, 2008

(54) Joining Panel

(75) Inventor: Franz Knauseder, Salzburg (AT)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Kaindl Flooring GmbH, Wals (AT)

(21) Appl. No.: 10/593,057

(22) PCT Filed: Feb. 21, 2005
(86) PCT No.: PCT/AT2005/000054

§ 371 Date: Aug. 12, 2008

(30) Foreign Application Priority Data
Mar. 23, 2004 (AT) A511/2004

(51) Int. Cl. E04C 2/00; F16B 5/00

(52) U.S. Cl. 52/589.1; 403/336

(57) ABSTRACT

Covering panel(s) for floors have a groove (12) along at least one edge and have a tongue (6) along another edge (17). Panels (1, 2) to be joined to one another can be joined by inserting the tongue (6) into the groove (12). A bead (8) made of an adhesive and/or plastic is placed on or affixed to at least one tongue surface (7). According to the invention, a recess (3) is formed in the tongue surface (7) and serves to accommodate the bead (8), and a detent recess (5), which is delimited by a detent surface (4), is formed in the inside wall surface (15) of the groove, this surface facing the tongue surface (7). When the tongue (6) is inserted into the groove (12), the bead (8) projects into the detent recess (5) whereby enabling the bead (8) and the detent surface (4) to latch.

### CROSS-REFERENCES TO RELATED APPLICATIONS

This application claims the priority of Austrian Patent Application A 511/2004 filed Mar. 23, 2004, and is a U.S. National Phase application of PCT/AT 2005/000054 filed Feb. 21, 2005, both of which disclosures are incorporated herein by reference.

### BACKGROUND OF THE INVENTION

The invention concerns a covering panel for floors, walls or ceilings or similar purposes of use in accordance with the introductory clause of claim 1.

Such panels have grooves and tongues on their lateral surfaces in order to be able to install these panels in a formation. In order to achieve a formation as stable as possible, it can also be provided that the panels be cemented to one another.

From the prior art, interlocking elements have become known, which are cooperating or which fit to one another, sealing material being applied for sealing the interlocking regions or an adhesive is introduced for forming a connection of the interlocking elements. This sealing material or this adhesive, however, do not act per se as an interlocking element and do not contribute to a mechanical force-locking or positive lock of two panel elements to be interconnected.

### BRIEF SUMMARY OF THE INVENTION

The priority object of the invention is to be able to manufacture panels of the above-mentioned type as easily and economically as possible, furthermore to enable their storage over longer time intervals without adverse effects and in a space-saving way, and finally to make installation, and optionally dismantling, as panel conserving, fast and simple as possible. Another object is to prepare a stable, durable and solid surface from the interconnected panels; during installation, however, an alignment of the panels should be possible over a certain time interval. The groove and the tongue should be able to be produced in a stable and simple way, and should well be able to be latched; the bead or web of an adhesive and/or of a plastic material should be able to be applied in a simple and durable way.

These objects are achieved with a covering panel of the type described at the outset which has the characteristics indicated in the characterising clause of claim 1.

According to the invention, in the groove or on at least one inner surface of one of the legs of the groove a, particularly specially formed, detent recess, and in a specially formed recess in at least one surface of the tongue a bead or web is applied, which may be latched to one another. In this way, the bead and the detent recess act as locking devices in the course of installation of the covering panels or in the course of their joining; the bead and the detent recess interact as detent or locking elements. The bead of plastic material and/or the adhesive are applied, e.g. sprayed on, at the factory in an simple and quick procedure.

With the construction of the covering panels according to the invention, a precise engagement of the tongue to the inner wall surfaces of the groove is achieved, and the detent recess in the inner wall surface of the groove can precisely cooperate with the bead, that is placed in the recess of the tongue surface, so that the mutual position of the panels to be interconnected is precisely secured. With an appropriate shape of the bead, cementing between the tongue and the groove is also possible; as far as cementing is not effected in the course of joining the panels, these panels may be separated and also reassembled again. The latching connection provided, thus, allows multiple catching and subsequent separating of the panels.

This type of connection, and optionally cementing, technique may be used for covering panels of any material, such as wood, wooden materials, particularly MDF, HDF, chips and so on.

There is a series of plastic materials that should be considered, and which may be used and applied as an appropriate bead or web. In particular, silicone plastics, plastics based on polyalkylene, particularly PVC, PE, PP, as well as hot-melt adhesives based on neoprene may be considered. Such plastics should be deformable by heat or adhere by heat, and it should be possible to extrude or shape them in bead form, and they should be able to solidify adhering to the respective material of the panel. In use, they should have a appropriate elasticity and viscosity in order to be able to act as a catch element. The beads are tenacious-elastic or viscous-elastic or relative hard.

As plastics deformable by heat, particularly thermoplastics, elastomers or thermoplastic elastomers are considered. As thermoplastics, polyolefins, vinyl polymers, polyamides, polyester, polyurethane and ionomers may be used. As elastomers, various types of rubber may be employed. As thermoplastic elastomers, above all TPE, TPR, TPO, SPS, TP-Q, TP-U are considered. As plastics, hot-melt adhesives or hot sealing adhesives based on ethylene vinyl chloride, PA, PU or EVA may also be employed. Other plastics can also be used.

The adhesives should have a sufficient strength in order not to be removed, when the tongue is pushed into the groove, or to be damaged in their surface configuration, but as a result of penetrating atmospheric humidity and/or by applying water in the course of installing them or of use, they should be able to be activated enough to fully develop their adhesive action. After hardening of the adhesive of the bead(s) of adhesive, they act, on the one hand, due to the adhesive action and, on the other hand, due to the developed locking action; the beads cooperate with the material of the tongue or of the groove. The adhesives and plastics used should be applicable by a nozzle to the respective material of the panel, and should well adhere there.

Advantageously, adhesives and/or the plastics may be used, which are watertight or water resistant or solidify in a waterproof manner so that the material of the panels, particularly MDF or HDF can be protected against moisture. Spilt water cannot penetrate the panels, but can only reach the bead from above, and can also not affect or destroy the beads formed; moisture which rises from the bottom is prevented from escaping.

In an advantageous manner, the adhesive and/or the plastic material may be tenacious-elastic. When assembling the panels, the adhesive and/or the plastic material have sufficient tenacity to yield elastically to deformations and to give way to loads, which otherwise would cause some damage. The possibility of a tenacious-elastic deformation improves the sealing behaviour and enables a corresponding elasticity so that movements of the panels relative to each other, which are due to changes of temperature and/or load and/or humidity, particularly expansion or shrinkage of joined panels, can elastically be absorbed, and developed gaps can be regenerated. In this way, the load of installed and interconnected panels, in general, and wear developed by going in the region of the joint are reduced. An elastically deformable adhesive or plastic material adapts itself to the respective counter-profile and improves the fit. Finally, with an elastically deformable adhesive and/or plastic material, the legs of the groove need not to be expanded so far, if a certain regenerating deformation of an elastic adhesive and/or plastic material is permitted to occur during introduction. Furthermore, a tenacious-elastic bead enables repeated assembling and separating of the panels without affecting their shape and without losing their function.

The adhesive and/or plastic material, which adheres to the surface of the groove and/or of the tongue, protects and reinforces the supporting surface. In this way, it is possible that less requirements with respect to their precision have to be made to the milling tools used. The applied bead or web covers weak points of the milled surface, e.g. tears, fuzz or the like, and equalises them. Thus, the service life of the wood milling tools used can be prolonged.

Such covering panels have the advantage that the operation work and the manipulation steps, when installing the panels on the spot, are substantially reduced; it is only necessary to introduce water into the groove and/or to apply it to the tongue with an appropriate means to activate the adhesive, if this is desired at all. If it is an adhesive, which hardens due to the humidity present in the ambient, even this procedure is not necessary.

A particular advantage resides in that a correctly measured and sufficient quantity of adhesive is present due to the mass of adhesive given in the factory to the adhesive bead, and that any manipulation or removal of some adhesive, which might be superfluous, or leakage of the adhesive from the groove/tongue connection is avoided.

For obtaining the latching and/or adhesive connection, relative small quantities of adhesive are sufficient. The effect of the beads is supported by a contact of an area as large as possible between the groove and the tongue.

It is definitely possible that an expansion of the legs of the groove occurs due to an over-measure or an oversize of the bead, when introducing the tongue provided with the bead into the groove. In the course of the installation or in the course of the use, it may be achieved, due to penetrating atmospheric moisture or by applied water during installation or by appropriate solvents, that the bead is softened and deformed and adapts itself to the shape given by the inner wall surface of the groove, by which the elastically expanded groove legs are enabled to reassume their initial given shape or position. Such a deformed bead establishes a good adhesive connection between the groove and the tongue.

As an adhesive, in particular, glues too may be considered which consist of a water-soluble, animal (glutine, casein), vegetable (starch, dextrin, cellulose ether) or synthetic (e.g. polyacrylic acid derivatives, polyvinyl alcohol, polyvinyl pyrrolidone) polymers and water as the solvent. They belong to the class of single-component cold-bonding adhesives in which the solvent (water) is sucked up or escapes during the cementing process. These glues solidify as they cool down, particularly in a jelly-like form, and mostly dry to a transparent mass which decomposes upon contact with water into a gel with a high adhesive force.

It is preferred, if an adhesive prepared with water or an adhesive dispersed in water or a glue is applied as an adhesive bead and is dried in situ or at the factory. By applying water at the consumer directly onto the dried adhesive layer or by indirect intensive contact with water, which has been applied to a panel to be joined or to its groove or tongue, or by penetrating moisture, the dried adhesive is activated and returns to the active state ready for adhesion after the panels have been joined to one another. The application of the aqueous activator can take place by spraying it on or by application by means of a sponge or the like.

In an advantageous procedure, first the adhesive beads are moistened with water or a film of water, which at least wets the adhesive bead, is applied or is sprayed onto the tongues and/or into the grooves of the panels as the adhesive activator, and then the panels are joined to one another. The availability time of the reactivated adhesive is chosen such that there is enough time for joining the panels to one another.

If the bead or web is made of plastic material, this embodiment has the advantage that the groove or tongue can easily be locked to one another; if the bead or web is formed from an adhesive, locking may be effected by being accompanied by cementing.

It is of advantage, if the features of claim 4 are implemented. With such a construction of tongue and groove, the cohesion of two covering panels to be joined together is improved and a covering is achieved which as substantially a considerable stiffness. In this case, the adhesive of the adhesive beads is able to support the particularly intimate connection between the tongue and the groove.

It is advantageous, if the features of claim 6 are satisfied. In this way, the risk of damage or of shearing off an adhesive bead or a plastic bead, when pushing the tongue into the groove, is reduced, and its hold on the surface, where the bead adheres, is increased. In this connection too, it is advantageous, if the adhesive bead adheres strongly in its recess and/or to the wall surfaces of the groove and/or to the tongue surfaces. This strong adhesion should not be lost, even if the adhesive is activated by contact with water, and in particular, this adhesion is to be made as strong as possible.

It is advantageously provided that the tongue and the groove are each formed lengthwise or in one longitudinal side and/or along and in a transverse side of a panel, the tongue and/or the groove and/or the beads or webs extending optionally over the entire length of the respective side surface. Thus, an optimum joining capacity and an optimum cohesion are achieved over all sides of the covering panels when installing them together with the covering panels to be joined.

With plane walls or surfaces, assembling of the plane surfaces is possible with small energy consumption; it is only necessary to overcome the bulges formed by the applied beads in order to insert them into the recesses. It is of advantage, if at least one leg, preferably the lower one, of the groove may be elastically expanded or elastically bent when inserting the tongue and/or if the plastic material used and/or the adhesive possess(es) an appropriate elastic behaviour or such a viscosity. In this way, the bead is conserved when interconnecting the panels.

An elastic expansion of the legs of the groove that is carried out by an adhesive bead comprising a certain oversize, may be cancelled either partially, or to a high extent or completely in the course of the activation of the softening adhesive; thus, the cross-sections of the adhesive beads may have a certain oversize. Insofar the characteristics of claim 14 are advantageous.

In accordance with the invention, it may be provided that the adhesive of the adhesive beads or webs is water-soluble or can be partially dissolved and/or activated upon contact with or supply of water and/or moisture, and/or is formed by a water-soluble glue, e.g. white glue, and/or by a pressure adhesive or an adhesive, which develops an adhesive action when pressure is applied or which is a pressure-activated adhesive.

According to the invention, it may further be provided that the panel is formed of a wood material, MDF, HDF, a plastic material, recycled plastic material, chips with artificial resin or bonded chips (particle board), and is optionally provided with at least one coating, e.g. a decorative coating, particularly of plastic, decorative paper, wood or the like on its front surface or surface of use and/or on its back.

A good cohesion of two panels to be joined and of tongue and groove will result, if the characteristics of claim 13 are realised. With such an embodiment, the adhesive bead is in good contact with the detent recess.

It is of particular advantage, if according to the invention, the features of the characterising clause of claim 8 are fulfilled. In this way, deformation-resistant beads have a double function, i.e. they act as a locking element and as an element for interconnecting two panels.

The characteristics mentioned in claims 20 to 36 relate to preferred embodiments of the beads or the detent recess and the recess and offer, above all, a good contact of these elements and a durability when connecting as well as in use of the panels.

In the following, the invention will be described in detail with reference to the drawings, which represent exemplary and schematic embodiments of the invention.

### BRIEF DESCRIPTION OF THE DRAWINGS

FIG. 1 illustrates schematically the assembling of two covering panels;

FIG. 2 shows a schematic cross-section of the covering panels; and

FIG. 3 represents a detail of FIG. 2.

### DETAILED DESCRIPTION OF THE INVENTION

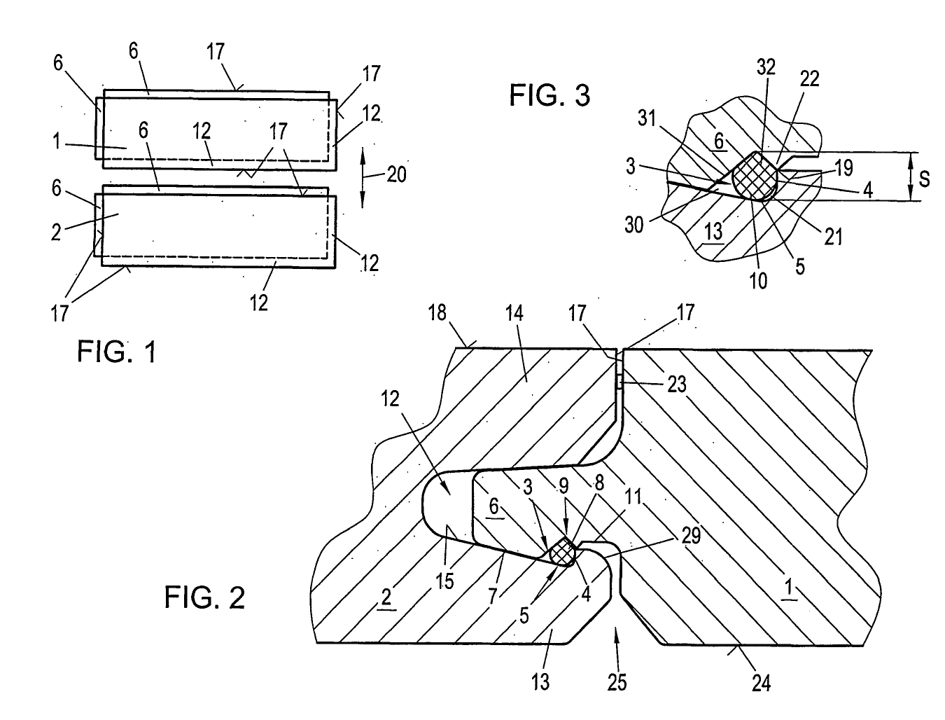

FIG. 1 illustrates schematically two covering panels 1, 2 which are to be pushed to one another in the direction of arrow 20 and should be joined to one another. This joining by displacement, as the last joining step, can and should be carried out only in the plane spanned by the two panels 1, 2. On their longitudinal sides and/or their narrow side, the two panels each have a tongue 6, which projects from the front surface 17, and a groove 12 formed in the front surface 17 at the opposite longitudinal side and/or narrow side. The same conditions may prevail on the front surfaces 17 of the narrow sides; each of the panels 1, 2 may have a groove 12 and a tongue 6 on the front surface 17 of these narrow sides.

The shapes of the tongue and the groove are matched to one another in order to ensure a good connection between the groove and the tongue. This shape allows insertion of the tongue 6 into the groove 12, when the panels 1, 2 are aligned in the plane of the panels. It is possible to connect the panels 1, 2 in a checkerboard manner or offset to one another. Connection both on the longitudinal sides and also on the narrow sides takes place by a displacement substantially in the plane spanned by the panels 1, 2. The type of connection according to the invention could also be provided on the transverse sides or the narrow sides of panels only, which on their longitudinal side are interconnected in a different manner, e.g. by pivoting or turning the panel to be joined.

FIG. 2 shows schematically a cross-section of two panels 1, 2 which have been assembled. The panel 1 has a tongue 6 which is inserted into a groove 12 of panel 2, until the front sides 17 or some projections or stops 23, formed on the front sides 17 in the upper area or in a region which is adjacent to the surface 18 of the panels 1, 2, engage each other. The boundary edges of the groove 12 and/or of the tongue 6 may be rounded or bevelled.

On at least one tongue surface, in the present case that tongue surface 7 which is remote from the surface, a bead 8 is applied in a recess 3 and adheres particularly firmly to the wall of the recess 3. At a location, which with joining panels corresponds or is associated, of that wall surface 15 of the groove 12, which in the present case is remote from the surface, or of inner surface of the lower leg 13, a detent recess 5 adapted to the position of the bead 8 is formed in the wall surface 15, which is otherwise preferably plane, particularly by forming a detent surface 4. When interconnecting the two panels 1, 2 and when inserting the tongue 6 into the groove 12, the bead 8 will be situated in a region behind a detent surface 4 of the detent recess 5 and can interlock with it.

Advantageously, it is provided that the adhesive of the adhesive bead or web 8 is water-soluble or may be partially dissolved and/or activated upon contact with or upon supply of water and/or moisture, and/or is formed by a water-soluble glue, e.g. white glue, and/or by a pressure adhesive or an adhesive which develops adhesive action when pressure is applied or which may be pressure-activated. Activation of the adhesive of the adhesive bead 8 may be effected by wetting the adhesive beads 8 with water before the panels 1, 2 are joined, or by introducing water into the groove 12 and/or onto the tongue 6. Depending on the choice of the adhesive, it can also be provided that, after locking of the adhesive bead 8 with the detent surface 4, atmospheric humidity penetrating during the use of the panels 1, 2 activates the adhesive capacity of the adhesive bead 8, thus establishing an adhesive connection between the tongue 6 and the leg 3 of the groove 12. In principle, adhesives could also be used, which are to be activated by substances other than water.

For joining the panels 1, 2, in the present case for inserting the tongue 6 provided with the bead 8 into the groove 12, it is provided that at least one leg 13, 14 of the groove 12 can be elastically widened or elastically bent up upon inserting the tongue 6.

In principle, it is possible to form the bead 8 or the detent recess 5 on one or on both tongue surfaces 7 or on one or both wall surfaces 15 of the groove 12.

It is advantageous, if both tongue surfaces 7 converge towards the free end of the tongue 6, and that the wall surfaces 15 of the groove 12 are inclined under the same angle as the tongue surfaces 7 and converge towards the interior.

It can apply to these and also all other embodiments, that advantageously the tongue 6 and the groove 12 may be positively or with a snug fit interconnected at least over part of the insertion area of the tongue 6, wherein that area of the tongue 6, which is located in front of the bead or web 8 towards the free end of the tongue 6 can positively be inserted or with a snug fit into the groove 12. It may be provided that the tongue 6 and/or the groove 12 and/or the bead 8 and the detent recess 5 extend over the entire length of the respective side surface 17 and/or that the bead 8 and the detent recess 5 and the recess 3 extend continuously over the length of the groove 12 and/or of the tongue 6 or are applied or formed in the form of individual successive segments.

As the material for the panels according to the invention, it is advantageously provided that the panel 1, 2 are formed of wood, wood material, MDF, HDF, plastic material, recycled plastics, chips with artificial resin or bonded chips (particle board), and optionally are provided on their front surface or the surface of use 18 and/or on their back 24 with a respective coating, e.g. a decorative coating, particularly of plastic material or decorative paper. Furthermore, it may be provided in an advantageous manner that the groove 12 and the tongue 6 are formed of the material of the panel or are milled out from it or that the tongue 6 is integrally formed with the material of the panel 1, 2.

It may be provided that part of the bead or the web 8 is arranged in a countersunk manner within the recess 3 which is formed in the tongue surface 7. The shape of the recess 3 assist in that the applied bead 8 is firmly connected to the tongue surface 7 and does not shear off or loosen when inserting the tongue 6 into the groove 12. As is represented in FIG. 3, the recess 3 may also comprise an area 30 which is free of bead material and is optionally filled with bead material, when the bead 8, which spreads the legs 13, 14 of the groove 12, softens during the cementing procedure in the case of an oversize or due to its thickness, and the bead material is pressed in the area 30.

In most cases, it should be avoided that the legs 13, 14 of the groove 12, which are elastically widened when the tongue 6 is inserted into the groove 12, remain in the widened position. In the widened state, the joint between the surfaces 18 of both panels 1, 2 could form a step, which would be subject to increased wear, unless it is only the lower leg, which remains elastically widened. In a particularly advantageous embodiment of the invention, it is provided that the leg 14 near the upper surface of the groove 12 is made stronger or less elastic, particularly inelastic at all, and that it is only the lower leg 13 near the bottom of the groove which is made to be elastically deflected. In this way, it can be avoided that the upper leg near the upper surface may bend up by large or less deformable beads 8, but it is only the lower, weaker or thinner leg 13 of the groove 12 which is bent. In an advantageous manner, to prevent the upper leg 14 from being bent up, it may also be provided that the bead 8 is formed only on the downwards directed tongue surface 7 or that the detent recess 5 is formed in the wall surface 15 of the lower leg 13 of the groove 12. In this way, both the tongue 6 and also the upper leg 14 of the groove 12 would counteract arching of the connecting site, when the extent or the volume of the bead is dimensioned too large, or when using an adhesive that has not been made soft enough and/or the free volume 30 provided for it and/or the area 21 between the groove and the tongue have not been sufficiently dimensioned.

It may be advantageous, if the front edge areas of the groove 12 are rounded or comprise chamfers 29, as is represented in FIG. 2, in order to be able to gently insert the bead 8 when inserting the tongue 6 into the groove 12.

In the region of the panels 1, 2, which are remote from the upper surface or are near the bottom, is provided that the front surfaces 17 do not touch each other and that a gap 25 is formed in-between. This is particularly achieved in that the leg 13 of the groove, which is near the bottom, is insignificantly shorter than the leg 14, which is near the upper surface.

It may be provided that the adhesive bead or web 8 comprises an adhesive-latent adhesive, preferably a polymer adhesive which can be emulsified in water, the adhesive being able to be converted into a condition ready-for cementing or of adhesiveness by moistening with water. The plastic material or the adhesive of the adhesive bead or web 8 to be (re)activated by water or moisture may be applied with a substantially uniform thickness S of the entire layer of 0.5 to 0.9 mm, particularly of 0.6 to 0.8 mm, with thickness tolerances in the range of ±0.05 to 0.1 mm. The adhesive of the adhesive bead or web 8 may be formed by a quick-setting or a mounting glue based on polyvinyl acetate, such as Dorus MDO 55 of Henkel, or by a commercial wood glue, e.g. based on starch and/or protein.

When appropriately rounding the edges of the free ends of the tongue 6 and/or when rounding the inner edges of the wall surfaces 5 of the legs 13, 14 of the groove 12, it is possible during installation, first to place the panels 1, 2 to be joined to one another also at a certain angle in order to achieve the insertion of the tongue 6 into the groove 12 to a certain extent. The final latching of the tongue 6 and the groove 12 or the last locking step, that ends when the front surfaces 17 contact each other in the area near the upper surface, it is, however, only possible, if the panels 1, 2 are pushed relative to each other in the panel plane.

Care should be taken that the adhesive is appropriately softened or becomes soft so that no unevenness is developed in the joint area of the panels 1, 2 to be joined to one another. The amount of adhesive to be applied in the adhesive bead 8, above all, depends on the geometrical circumstances between the tongue 6 and the groove 12 and on the size of the recesses 3 or the free area 30 of the detent recess 5 and/or on the size of the area 21, and particularly also upon the viscosity of the reactivated adhesive.

From FIG. 3, the special shape of an advantageous recess 3 may be seen. The recess 3 has a triangular cross-section and extends within the tongue plane 7 and, starting from that to the interior of the tongue 6 to a basis 9, which in the present case is formed by a terminal edge, and from it in a direction away from the tongue 6 to a limiting wall 22 which, in turn, has a triangular cross-section and passes over into the surface areas 11 of the tongue 6 which are near the groove surface.

The tip or edge of the wall area 22 is substantially above the end edge or corner edge to which the detent surface 4 issues. The recess 3, which substantially has a triangular cross-section, receives a partial portion or the basis 32 of the bead 8; a portion 10 of the bead projects from the recess 3 in order to engage the detent surface 4 and, in some cases, the inner wall surface 15 of the groove. Between the bead 8 and the rounded transition between the detent surface 4 and the inner wall surface 15 of the lower leg 13 of the groove 12 is a free, meniscal area 21.

The detent surface 4 engages the portion 10 of the bead 8, which projects from the recess 3, thus locking the tongue 6 in the groove 12.

At both sides of the projecting portion 10 of the bead 8 is a respective free space, i.e. the meniscal space 21 and the free space 30. These spaces are provided to receive dust and/or bead material in the case that the bead has a height S, that would provoke spreading open of the legs 13 and 14, when the tongue is inserted into the groove. Excess material, in the case of an adhesion of the material of the bead at the same time with the detent surface 4 and/or the surface of the area 21 and/or the surface 15 of the groove, could enter these spaces upon partial dissolution or softening of the material of the bead 8.

The stops 23 are formed on at least one of the two front surfaces 17 and, to a large extent, fix penetration of the tongue 6 into the groove 12, so that the tongue 6 does not enter the groove 12 too far, so that it does not spread the legs 13 and 14, but is, nevertheless, received by the groove 12 without any play.

The grooves 12, the tongues 6 together with the recess 3 and the detent recess 5 are preferably produced by milling.

The shape of the grooves 12 and of the tongues 6, in an advantageous manner, fit to one another, but this is not necessarily required. Even grooves and tongues, whose shape does not fit, are able to be held together by the beads 8 formed and applied in accordance with the invention.

The beads 8 may also be applied in the form of subsequent segments, i.e. optionally with interruptions.

1. Covering panel(s) for floors, walls and ceilings, formed preferably of wood, wood material, MDF, HDF, plastic material, recycled plastics, chips with artificial resin or bonded chips (particle board), the covering panels comprising a groove (12) along at least one edge or front surface (17) and/or a tongue (6) along at least one different edge or front surface (17),
panels (1, 2) to be joined together being interconnectable by inserting the tongue (6) into the groove (12) in the course of a displacement which substantially takes place in the panel plane, and
a bead or web (8) of an adhesive and/or of plastic material being applied or bonded, particularly at the factory, to at least one tongue surface (7),
wherein
a recess (3) is formed in the tongue surface (7) and receives in part said bead or web (8) of an adhesive and/or of plastic material, and
a detent recess (5), delimited by a detent surface (4), is formed in that inner wall surface (15) of the groove which faces the tongue surface (7), into which detent recess (5) the bead or web (8) projects, when the tongue (6) is inserted into the groove (12), or by which detent recess (5) that portion (10) of the bead (8) which projects from the recess (3) is encompassed or received,
so that the bead (8) and the detent surface (4), after insertion of the tongue (6) into the groove (12), can be interlocked and/or interconnected or, in joined condition of two adjacent panels (1, 2), are interlocked and/or interconnected.

2. Panel(s) according to claim 1, wherein the groove (12) and the tongue (6) are each formed on a longitudinal side and on a transverse side of a panel (1, 2) in or on a front surface (17) thereof.

3. Panel(s) according to claim 1, wherein
the thickness of the tongue (6) decreases towards the free end, wherein at least one tongue surface (7) is inclined relative to the surface of the panels (1, 2) and
the wall surface(s) (15) of the groove (12) extend under the same angle as the associated or engaging tongue surface(s) (7).

4. Panel(s) according to claim 1, wherein
the tongue (6) and the groove (12) can be interconnected, at least over part of the surfaces (7, 15) facing each other, in a positive way or with a snug fit
and/or
at least that area of the tongue (6) which is situated before the bead or web (8) towards the free end of the tongue (6) can be positively inserted into the groove (12) or with a snug fit.

5. Panel(s) according to claim 1, wherein the tongue (6) and/or the groove (12) and/or the bead or web (8) and/or the detent recess (5) extend over the entire length of the respective lateral surface (17), or wherein the groove (12) and/or the tongue (6) and/or the bead (8) and/or the detent recess (5) extend in the form of successive, spaced segments or bead segments or recesses along the lateral surface (17).

6. Panel(s) according to claim 1, wherein part of the bead or web (8) is countersunk in the recess (3).

7. Panel(s) according to claim 1, wherein the adhesive of the bead or web (8) is water-soluble or can be partially dissolved and/or activated upon contact with a supply of water and/or moisture, and/or is formed by a water-soluble glue, e.g. white glue, and/or by a pressure adhesive or an adhesive which develops an adhesive action when pressure is applied or is a pressure-activated adhesive and/or is formed by a quick-setting or a mounting glue based on polyvinyl acetate and/or by a commercial wood glue, e.g. based on starch and/or protein.

8. Panel(s) according to claim 1, wherein the adhesive of the bead or web (8) has such a hardness or tenacity or viscosity that it stands insertion of the tongue (6) into the groove (12) or widening of the groove (12) during insertion of the tongue (6) and sliding of the groove leg over it without a substantial remaining change of shape, and wherein it acts as a locking element against escaping of the tongue (6) from the groove (12) after insertion of the tongue (6), optionally as long as up to the moment where an adhesive effect occurs.

9. Panel(s) according to claim 1, wherein
the legs (13, 14) of the groove (12) have an equal length and/or
the leg (14) of the groove (12) which is at the back of the panel (1, 2) is insignificantly shorter than the leg (13) which is near the front surface of the panel (1, 2) and/or
at least one leg (13, 14) of the groove (12), preferably the lower leg (14), can be elastically widened or can be elastically bent up when the tongue (6) is inserted.

10. Panel(s) according to claim 1, wherein
the groove (12) and the tongue (6) are formed of the material of the panel (1, 2) or are milled out of it, or
the tongue (6) is integrally formed of the material of the panel (1, 2).

11. Panel(s) according to claim 1, wherein in the region of the upper surfaces or surfaces of use (18) of two interconnected panels (1, 2) the areas of the front surfaces engage each other and wherein, optionally, a gap (25) is formed in the region of the back (24) of the interconnected panels (1, 2) between the front surfaces (17).

12. Panel(s) according to claim 1, wherein the portion (10) of the bead or web (8) which projects from the recess (3) and/or the detent recess (5) comprise a rounded contour in cross-section, particularly a lens-shaped, half-elliptic or circular contour.

13. Panel(s) according to claim 1, wherein the projecting portion (10) of the bead or web (8) acts as a detent or locking element and/or as an element, which develops an adhesive effect.

14. Panel(s) according to claim 1, wherein the adhesive of an applied bead or web (8) is deformable, particularly under the action of water and/or moisture and/or continuous pressure, and optionally adapts itself to the cross-sectional shape of the detent recess (5), particularly while simultaneously developing its adhesive action, or fills the free space of this detent recess (5) so far as an adhesive mass is in excess.

15. Panel(s) according to any claim 1, wherein the bead or web (8) firmly adheres in the recess (3).

16. Panel(s) according to claim 1, wherein the bead (8), in locked or latched position of the groove (12) and the tongue (6), engages the detent surface (4) and optionally the groove surface (15), particularly in a position where it engages one of these surfaces in pressure biasing manner.

17. Panel(s) according to claim 1, wherein the adhesive bead or web (8) comprises an adhesive-latent adhesive, preferably a polymer adhesive which can be emulsified in water, the adhesive being able to be converted into a condition ready for cementing or for adhesion by moistening with water.

18. Panel(s) according to claim 1, wherein the plastic material or the adhesive material of the adhesive bead or web (8), which is able to be (re)activated by means of water or moisture, is applied with a substantially uniform layer thickness of 0.5 to 0.9 mm, particularly of 0.6 to 0.8 mm, with thickness tolerances in the range of ±0.05 to 0.1 mm.

19. Panel(s) according to claim 1, wherein the leg (3) of the groove (12) near the upper surface is made stronger or thicker and/or so as to be bent in a less elastic manner than the lower leg (4) and/or wherein the bead (8) is only formed on the downwards directed tongue surface (7), while the detent recess (5) is formed only in the wall surface of the lower leg (4) of the groove (12).

20. Panel(s) according to claim 1, wherein the bead (8) and the detent surface (4) of the detent recess (5) grip behind one another.

21. Panel(s) according to claim 1, wherein the bead (8), in locked position of the groove (12) and the tongue (6), is under a pressure or force bias by at least one groove leg (13, 14), which has been widened open when inserting the tongue (6) into the groove (12).

22. Panel(s) according to claim 1, wherein the bead (8), at least in segments, extends parallel to and along the edges of the front surface (17) or in longitudinal direction of the panel (1, 2).

23. Panel(s) according to claim 1, wherein the recess (3) in the tongue (6) has a triangular cross-section, the area of the inner triangle edge being optionally rounded.

24. Panel(s) according to claim 1, wherein the depth of the recess (3) amounts to 30 to 55%, preferably 36 to 48%, of the total thickness or height of the bead (8).

25. Panel(s) according to claim 1, wherein the cross-section of that portion of the bead (8) which projects from the recess (3) is rounded in a circular or elliptic or lens-shaped fashion.

26. Panel(s) according to claim 1, wherein the recess (3) is formed in a region of the tongue (6) which stands back from the tongue surface (7) in the direction to the front surface of the panel (1, 2) or forms a standing-back region of the tongue surface (7).

27. Panel(s) according to claim 1, wherein the detent surface (4) is formed by or results from a prolongation of the inner wall surface of the groove or joins to it, and is inclined to the surface of the panel (1, 2) under an angle of 95 to 105°, preferably of 97 to 103°, and in particular is perpendicular to the surface.

28. Panel(s) according to claim 1, wherein the transition from the inner wall surface (15) of the groove, which delimits or forms the detent recess (5), to the detent surface (4) is rounded.

29. Panel(s) according to claim 1, wherein, in latched position of the groove (12) and the tongue (6), a gap (21), particularly a meniscal one, is formed between the bead (8) and the rounded transition (11).

30. Panel(s) according to claim 1, wherein that region (32) of the bead (8) which is next to the front surface (17) of the panel (1, 2) comprising the tongue (6) engages the detent surface (4).

31. Panel(s) according to claim 1, wherein the terminal region (22) of the recess (3) is situated opposite the detent surface (4), which preferably is formed in the shape of a delimiting wall that has a triangular cross-section.

32. Panel(s) according to claim 1, wherein the region of the front surfaces (17) above the groove (12) near the upper surface and/or the tongue (6) includes a stop (23) for delimiting the insertion of the tongue (6) into the groove (12) wherein at least one spacer (23) is arranged which determines the distance of the opposite front surfaces (17) of the panels (1, 2) to be interconnected.

33. Panel(s) according to claim 1, wherein that portion of the groove surface (15) which extends over the recess (3) when the groove (12) and the tongue (6) are latched engages the bead (8).

34. Panel(s) according to claim 1, wherein the transition area from the inner wall surface (15) of the groove, where the detent recess is formed, to the front surface of this groove leg (13) is rounded.

35. Panel(s) according to claim 1, wherein the detent recess (5) and the recess (3) and the bead (8) extend at least along a portion parallel to the respective front surface or side edge or to the longitudinal direction of the panel (1, 2).

36. Panel(s) according to claim 1, wherein a free space (30) is formed by the recess (3) between the bead (8) and the surfaces (31) of the recess (3), which join the tongue surface (7) and extend into the interior of the tongue (6).
